(19) United States
(12) Patent Application Publication
(10) Pub. No.: US 2014/0139791 A1
(43) Pub. Date: May 22, 2014

(54) METHOD AND DEVICE WITH ENHANCED DISPLAY EFFICIENCY

(71) Applicant: MOTOROLA MOBILITY LLC, Libertyville, IL (US)

(72) Inventors: William P. Alberth, JR., Prairie Grove, IL (US); Zhiming Zhuang, Kildeer, IL (US)

(73) Assignee: MOTOROLA MOBILITY LLC, Libertyville, IL (US)

(21) Appl. No.: 13/682,099

(22) Filed: Nov. 20, 2012

(51) Int. Cl. G02F 1/1335

(52) U.S. Cl. CPC G02F 1/133514; Y10S 977/774; Y10S 977/952; B82Y 20/00
USPC 349/106; 977/774; 977/952

(57) ABSTRACT

A method (300) and device (400) with enhanced display efficiency is disclosed. The method (300) can include: emitting (310) light from a source including a first light; converting (320) the first light of a single color to at least a second light with a color gamut of converted light, the converting including a layer of pixilated nanomaterial; and filtering (330) to reject light that is not converted. Advantageously, the method provides a low power consumption display. The method is particularly adapted for use in electronic devices with batteries such that it can help to increase the useful life of the battery.

### BACKGROUND

1. Field

The present disclosure relates to a method and device with enhanced display efficiency.

2. Introduction

As background, many wireless communication devices, such as smart phones and tablets, can barely get through a day on a single charge with normal use. With high use, or if the user cannot charge an electronic device at the end of the day, then a user will be left with a dead battery, resulting in a non-operational device, unable to receive calls, place calls, surf the web and the like.

Displays are using an increasing percentage of battery power consumed in electronic devices, especially wireless communication devices. Increasing the efficiency of displays can improve battery life and user experience. There is a need for methods and devices with enhanced displays with efficient power characteristics, for use in connection with electronic devices. There is a need for using efficient displays configured to improving the battery life in electronic devices.

It would be considered an improvement in the art, if a method and device with low power consumption displays were developed, for example, in connection with electronic devices, such as wireless communication devices.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary block diagram of a communication system according to one embodiment.

FIG. 2 is an exemplary block diagram of an electronic device in the form of a wireless communication device with an enhanced low power consumption display according to one embodiment.

FIG. 3 is an exemplary block diagram of a method with enhanced display efficiency according to one embodiment.

FIG. 4 is an exemplary block diagram of a device with enhanced display efficiency according to one embodiment.

FIG. 5 is an alternate exemplary block diagram of a device with enhanced display efficiency according to one embodiment.

### DETAILED DESCRIPTION

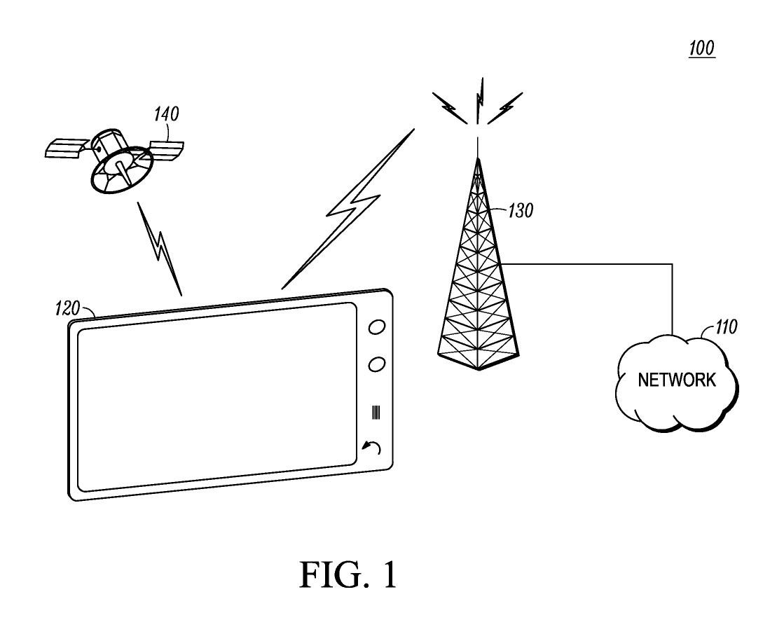

FIG. 1 is an exemplary block diagram of a system 100 according to one embodiment. The system 100 can include a network 110, a terminal 120, and a base station 130.

The terminal 120 may be a wireless communication device, such as a wireless telephone, a cellular telephone, a personal digital assistant, a pager, a personal computer, a tablet, a selective call receiver, or any other device that is capable of sending and receiving communication signals on a network including a wireless network. The network 110 may include any type of network that is capable of sending and receiving signals, such as wireless signals. For example, the network 110 may include a wireless telecommunications network, a cellular telephone network, a Time Division Multiple Access (TDMA) network, a Code Division Multiple Access (CDMA) network, Global System for Mobile Communications (GSM), a Third Generation (3G) network, a Fourth Generation (4G) network, a satellite communications network, and other like communications systems. More generally, network 110 may include a Wide Area Network (WAN), a Local Area Network (LAN) and/or a Personal Area Network (PAN). Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals. In operation, the terminal 120 can communicate with the network 110 and with other devices on the network 110 by sending and receiving wireless signals via the base station 130, which may also comprise local area, and/or personal area access points. The terminal 120 is shown being in communication with a global positioning system (GPS) 140 satellite, global navigation satellite system (GNSS) or the like, for position sensing and determination.

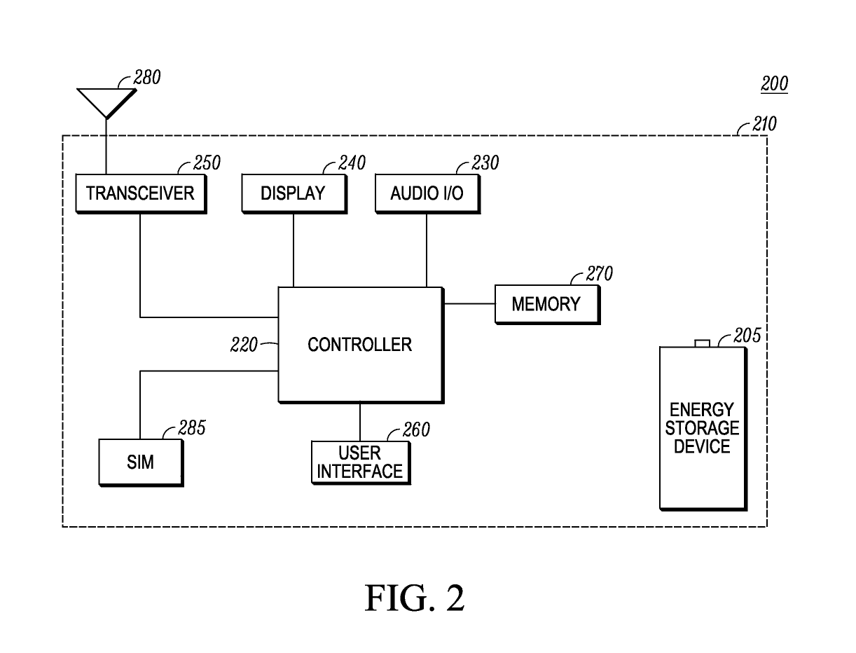

FIG. 2 is an exemplary block diagram of an electronic device 200, in the form of a wireless communication device configured with an energy storage device 205, such as in the terminal 120, for example. The electronic device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, an antenna 280 coupled to the housing 210 and the transceiver 250, and a removable subscriber module 285 coupled to the controller 220.

The display 240 can be a liquid crystal display (LCD), a light emitting diode (LED) display, organic light emitting diode (OLED), a plasma display, a touch screen display or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch screen or pad, a joystick, an additional display, or any other device useful for providing an interface between a user and an electronic device. The memory 270 may include a random access memory, a read only memory, an optical memory or any other memory that can be coupled to a wireless communication device.

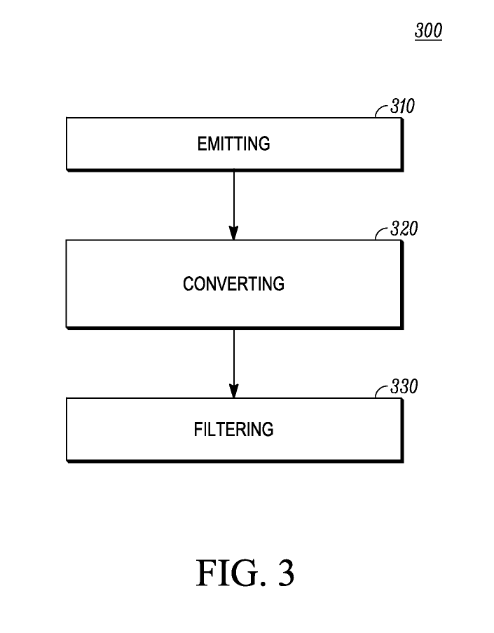

A block diagram of a method with enhanced display efficiency 300, is shown in FIG. 3. In its simplest form, the method 300 can include: emitting 310 light from a source including a first light; converting 320 the first light of a single color to at least a second light with a color gamut of converted light, the converting including a layer of pixilated nanomaterial; and filtering 330 to reject light that is not converted.

Advantageously, the method provides a low power consumption display. The method is particularly adapted for use in electronic devices using batteries.

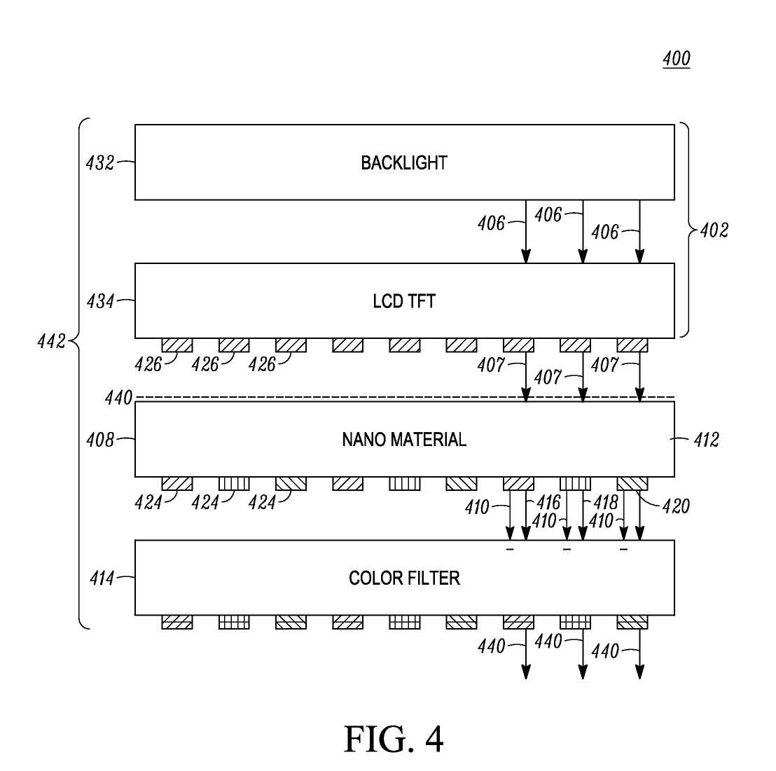

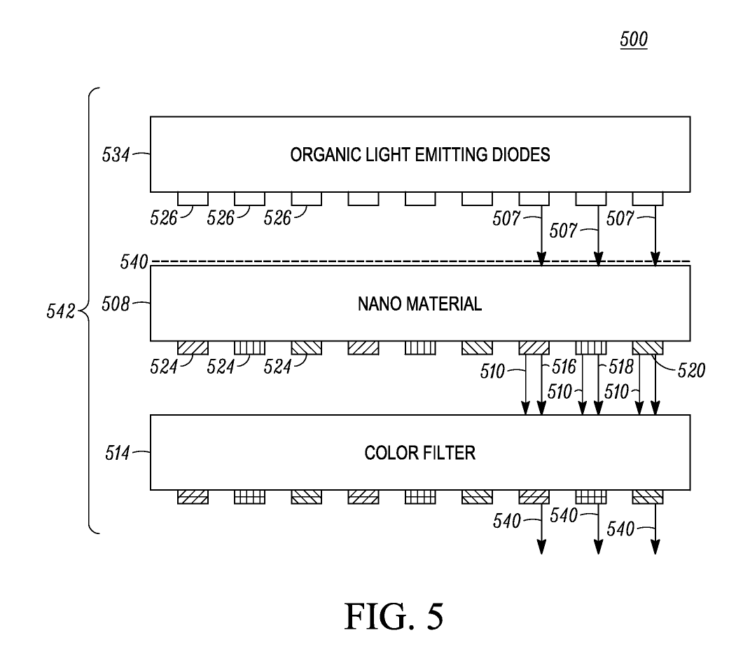

In one arrangement, the emitting step 310 includes providing at least one of a first module including a backlight module and a liquid crystal display, as shown in FIG. 4, and a second module including an OLED, as shown in FIG. 5. These options provide flexibility in connection with the design of an electronic device.

Advantageously, combining pixelated nanomaterial with an LCD in FIG. 4 or OLED in FIG. 5 in a display stack, can reduce the loss and complexity of a color filter and the overall complexity and cost of a display while improving efficiency, as detailed herein.

Advantageously, in an LCD embodiment in FIG. 4, a backlight can be reduced to a single color, the nanomaterial can convert the light to the correct color pixel by pixel and a simple color filter can eliminate leakage light and substantially prevent light from the viewing angle from exciting the nanomaterial.

Advantageously, in an OLED embodiment in FIG. 5, the OLED with a plurality of pixels can all with substantially the same wavelength can be utilized. This can significantly reduce the cost and complexity of fabricating an OLED display. The nanmomaterial can convert most of the light to the correct R, G and B color, pixel by pixel. And a single color, color filter can be used to clean up the picture, eliminate leakage light, and prevent incident light from the viewing angle from exciting the nanomaterial. In contrast, known conventional prior art, patterns the OLED three times to deposit material for Blue, Green, and Red LEDs, which is complex and disadvantageously leads to lower yields in manufacture.

Returning to FIG. 3, the emitting step 310 can include providing a single color backlight and a liquid crystal display (LCD) thin filmed transistor (TFT). The LCD provides pixel definition for the display. The LCD can allow light to pass through to enable each pixel or can substantially block light for each pixel to disable each pixel. This can provide a miniature, cost effective and efficient construction. In addition, the emitting step 310 can include providing pixel definition and output electrodes including a plurality of pixels being gated on or off to present information, as shown for example in FIG. 4.

In one embodiment, the converting step 320 can include converting the light energy from the backlight to a plurality of color gamuts including a red gamut, a green gamut and a blue gamut, which can contribute to enhanced power efficiency, for example, minimal power drain.

In contrast, many traditional displays require a backlight to emit near white light which includes red, blue, and green spectral components. The near white backlight is defined into pixels by an LCD, and the color filter will only allow the desired color for each pixel to pass. Thus the color filter in traditional displays needs to reject much of the incident energy for each pixel contributing to power losses and low efficiency.

In a preferred embodiment, the converting step 320 includes configuring the layer of nanomaterial to substantially minimize undesired color gamuts from passing. In a preferred embodiment, the converting step 320 includes configuring the layer of nanomaterial to substantially down convert the single color backlight into spacially pixilated R, G and B output according to an LCD subpixel format, to minimize undesired color gamuts from being absorbed by the color filter.

The layer of nanomaterial can vary. Many candidate types of nanomaterials can be used. Preferably, they include small nano dimensions such that incident light is reradiated at a desired wavelength. The nanomaterial can include sheets with trillions of tiny nanoscrystal phosphors, called Quantum Dots. These “dots” can be tuned, by changing their size, to emit light at predefined wavelengths and do so very efficiently.

Unlike conventional phosphor technologies such as YAG that emit with a fixed spectrum, quantum dots can actually convert light to nearly any color in the visible spectrum. Pumped with a blue source, such as a GaN LED, they can be made to emit at any wavelength beyond the pump source wavelength with very high efficiency (over 90% quantum yield) and with very narrow spectral distribution (only 30-40 nm FWHM.) An advantage of quantum dots is in the ability to tune the color output of the dots, by carefully controlling the size of the crystals as they are synthesized so that their spectral peak output can be controlled within about 3 nanometers to nearly any visible wavelength. In one embodiment, one nanomaterial can be a quantum dot enhancement material, such as one from Nanosys.

Nanomaterials can allow display designers to tune and match the display emission spectrum to the color filters. This means displays can be brighter, more efficient, and produce more vibrant colors. In one embodiment, the Nanomaterial is a drop-in layer or sheet.

Referring to FIG. 4, an enhanced display device 400 is shown. The device 400 can include: a light emitting module 402 configured to emit light from a source including a first light 406 including a first color gamut; converting module 408 configured to convert a first color gamut to a plurality of color gamuts according to a pixel configuration of a display, the converting module 408 including a layer of pixelated nanomaterial 412; and a color filter 414 configured to reject the first color gamut.

Advantageously, the device 400 can provide a portable, reliable, narrow profile and power efficient display stack 442.

In one example, the converting module 408 is configured to convert the first light 406 in the form of incident light, to at least a second color gamut, such as a red spectrum 416, a green spectrum 418, and a blue spectrum 420, of converted light via the layer of nanomaterial 408.

As shown in FIG. 4, the light emitting module 402 can include a backlight module 432 and LCD 434. Advantageously, the backlight module 402 emits light, such as blue light, the LCD 434 creates a pixel pattern, the nanomaterial layer 412 is laid down in a pattern to emit at least one of a plurality of color gamuts from a nano pixel 424, such as a red spectrum 416, or a green spectrum 418 or a blue spectrum 420, and a color filter 414 cleans up and eliminates undesirable backlight wavelengths and passes only the desired spectrum for each pixel.

Stated differently, in operation in FIG. 4, the backlight 432 emits light 406 of a single wavelength. The LCD 434 provides shutters for each pixel 426. The shutters can be individually controlled to allow light to pass through the LCD 434 to create pixelated light 407. A plurality of pixels 426 can be enabled or disabled via a shutter to block light 407.

The pixelated light 407 is incident on the nano material layer 408. The nanolayer 412 is laid down with a plurality of pixels 424. The nanolayer 412 is further patterned to provide pixels of nanomaterial which will emit red, green, or blue photons consistent with the construction of the display. The nano layer 412 absorbs the incident light 407 and converts most of the energy to red light 416, green light 418, or blue light 420. Some of the incident light 406 will leak through the nano layer 408, as undesired leakage light 410.

The color filter 414 is disposed adjacent to the nano layer 408, to reject the undesired leakage light 410, so that light 440 is only the desired red, green, and blue light in a pixel pattern, to display the desired image, as determined by the controller 220.

The color filter 414 may be constructed of red, green, and blue filters in line with the pixels of the display. The color filter 414 may also be constructed as a low pass filter to pass the desired red, green, and blue light and block the leakage light 410 which leaked from the backlight, for example. The color filter 414 may also be a band stop filter to block the leakage light 410. By implementing the display stack 442 in this manner, the color filter 414 can provide low loss resulting in a higher efficiency display.

The controller 220 can control which pixels 426 are enabled or disabled in the LCD layer 434. Each pixel 426 in the LCD 434, is aligned with a predefined red or green or blue pixel in the converting layer 408. Thus the controller 220 is able to control the image emitted by the display 400.

Turning to FIG. 5, a second embodiment of a display module 500 is shown, in the form of a display stack. The item numbers used in FIGS. 4 and 5 are similar and start at 400 and 500, respectively. The display module 500 in FIG. 5 is shown with an OLED 534, a layer of nano material 508 and a color filter 514. The OLED 534 has individual LEDs for each pixel 526, that can be enabled to transmit light to turn a pixel on, or disabled to turn a pixel off. The light 507 emitted from the OLED 534 may be of a substantially single wavelength. The OLED 534 can provide a robust, simple and cost effective component.

In contrast, many existing conventional OLED displays require each pixel to emit red or green or blue light which requires each color to be laid down, requiring additional cost, complexity and process yield loss, then the one shown in FIG. 5.

The pixelated light 507 is incident on the nano material 508, to convert the incident light 507 to red 516, green 518, or blue 520 for each pixel 524.

The color filter 514 can be constructed of red, green, and blue filters in line with the pixels of the display. The color filter 514 can also be constructed as a low pass filter to pass a desired color, such as a red, green, and blue light and block the leakage light 510. The color filter 514 can also be a band stop filter to block the leakage light 510.

By implementing this embodiment, the color filter 514 can thus be realized with significantly lower loss resulting in a higher efficiency display.

Disadvantageously, in many traditional displays, a light emitting module emits near white light, or a combination of red, green, and blue light. The color filter in traditional displays must then block undesired light for each pixel. This can result in significant loss of energy from the color filter.

Implementing one of the embodiments in FIGS. 4 and 5, allows the color filter 414 or 514, to be less lossy resulting in a higher efficiency display.

In a preferred embodiment the displays 400 or 500 in FIGS. 4 and 5, can include a thin short wavelength color filter 440 or 540, shown in dashed line, positioned in front of or upstream of a patterned RGB nano layer 408 or 508, to prevent or minimize the photo-luminescence by ambient light. Since the RGB light from a nano film is excited by short wavelength light from a backlight or a monochrome OLED behind it, it can also be excited by the ambient light from the front. Since such front photo-luminescence is not modulated or controlled by an electronic signal of a device, the ambient light can cause undesirable background noise that harms the contrast of a display, such as it can cause undesirable dark red or green pixel glow. A thin red and green color filter in the front can filter out the short wavelength ambient light from the red and green nano pixels and substantially prevent or minimize this from happening.

A thin blue color filter on the blue nano pixel can also make the emission spectrum of a nano particle in a pixel and a spectrum of ambient light come through from the front very close, make it unlikely for photo-luminance to occur. The wavelength difference between the exciting light and the resulting emission light is called Stokes shift. In photo luminescence, the excitation light wavelength and the resulting emission wavelength has to have a shift or difference between them for the color conversion.

In another embodiment, the light emitting module may emit light of a blue color of the correct wavelength, to fulfill the blue in a red, green, or blue display. The light may be generated by a backlight and then pixelated by a LCD layer or may be generated by an OLED where each LED can emit the desired blue wavelength. For example, the blue light then passes through a nano material layer where the blue light passes through the nano material layer for the blue pixels or in this particular instance, light could pass without nanomaterial, where the blue light is converted to green light for the green pixels, and where the blue light is converted to red light for the red pixels (in the above two instances nano material would be utilized).

The red and green pixels will have converted light plus blue light that was not converted. The filter layer 414 or 514 would then need to filter out the blue light for the green and red pixels. The filter layer 414 or 514 can additionally filter out lower wavelength (high frequency) light that would otherwise impact on the nanomaterial and create photoluminescence that would degrade the quality of the image from the display.

The combination of modules in FIGS. 4 and 5, can define a narrow profile display stack 442 and 542, for enhanced power performance and a portable construction.

In one embodiment, the electronic device 200 can comprise a wireless communication device, such as a cell phone or a tablet. The electronic device 200 can comprise an energy storage device.

In another embodiment, an electronic device 200 comprising: a housing 210; a display 400 or 500 comprising a light emitting module configured to emit light from a source including a first light; converting module configured to convert the first light to a plurality of color gamuts, the converting module including a layer of nanomaterial; and a color filter configured to reject undesired light for each pixel; and a controller 220 coupled to the housing, the controller configured to control the operations of the electronic device. This construction provides an improved electronic device with an efficient and enhanced display.

In one embodiment, the electronic device can include a wireless communication device and an energy storage device.

In one embodiment, the color filter is configured to reject light of at least one color with a shorter wavelength then the first light.

In one embodiment, the first light is of a blue color, where the converting module is configured to convert the blue light to green light for green pixels, the converting module is configured to convert the blue light to red pixels, and the converting module is configured to pass the blue light unchanged for blue pixels.

In one embodiment, the color filter is configured to reject blue light for red and green pixels, as detailed previously.

The method 300 can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments.

For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element.

Also, the term “another” is defined as at least a second or more. The terms “including,” “having,” and the like, as used herein, are defined as “comprising.”

We claim:

1. A method with enhanced display efficiency, comprising:
emitting light from a source including a first light;
converting the first light of a single color to at least a second light with a color gamut of converted light, the converting including a layer of pixelated nanomaterial; and
filtering to reject light that is not converted.

2. The method with enhanced display efficiency of claim 1, wherein the emitting step includes providing at least one of a first module including a backlight module and a liquid crystal display and a second module including an OLED.

3. The method with enhanced display efficiency of claim 2, wherein the emitting step includes providing a single color backlight and a thin filmed transistor liquid crystal display.

4. The method with enhanced display efficiency of claim 1, wherein the converting step includes converting the single color to one of a plurality of colors including a red gamut, a green gamut and a blue gamut for each pixel of a display.

5. The method with enhanced display efficiency of claim 1, wherein the emitting step includes providing pixel definition including a plurality of pixels being gated on or off to present information.

6. A display device, comprising:
a light emitting module configured to emit light from a source including a first light including a first color gamut;
converting module configured to convert a first color gamut to a plurality of color gamuts, the converting module including a layer of pixilated nanomaterial; and
a color filter configured to reject the first color gamut.

7. The display device of claim 6, wherein the light emitting module includes at least one of a first module including a backlight module and liquid crystal display and a second module including an OLED.

8. The display device of claim 6 wherein the first color is blue, and wherein the converting is to at least one of red and green light.

9. The display device of claim 8 where the filter is designed to reject blue light for the green and red pixels.

10. The display of claim 9 where the filter is further designed to reject at least one wavelength shorter then the blue color emitted.

11. The display device of claim 6, wherein the emitting step includes providing pixel definition and output electrodes including a plurality of pixels being gated on or off to present information.

12. The display device of claim 6, wherein the light emitting module, the converting module and the color filter define a display stack

13. An electronic device, comprising:
a housing;
a display comprising a light emitting module configured to emit light from a source including a first light; converting module configured to convert the first light to a plurality of color gamuts, the converting module including a layer of pixilated nanomaterial; and a color filter configured to reject undesired light for each pixel; and
a controller coupled to the housing, the controller configured to control the operations of the electronic device.

14. The electronic device of claim 13, wherein the electronic device comprises a wireless communication device.

15. The electronic device of claim 13, further comprising an energy storage device.

16. The device of claim 13 wherein the color filter is configured to reject light of at least one color with a shorter wavelength then the first light.

17. The device of claim 15 wherein the first light is of a blue color, where the converting module is configured to convert the blue light to green light for green pixels, the converting module is configured to convert the blue light to red pixels, and the converting module is configured to pass the blue light unchanged for blue pixels.

18. The device of claim 17 wherein the color filter is configured to reject blue light and wavelengths shorter than blue, for red and green pixels.
